(19) United States
(12) Patent Application Publication
(10) Pub. No.: US 2015/0023418 A1
(43) Pub. Date: Jan. 22, 2015

(54) IMAGE PROCESSING APPARATUS AND IMAGE PROCESSING METHOD

(71) Applicant: FUJITSU LIMITED, Kawasaki-shi (JP)

(72) Inventors: Satoshi SHIMADA, Kawasaki (JP); Kimihiko KAZUI, Kawasaki (JP); Junpei KOYAMA, Shibuya (JP)

(21) Appl. No.: 14/331,366

(22) Filed: Jul. 15, 2014

(30) Foreign Application Priority Data
Jul. 16, 2013 (JP) 2013-147966

(51) Int. Cl. H04N 19/51; H04N 19/44; H04N 19/503

(52) U.S. Cl. CPC H04N 19/00684; H04N 19/00575; H04N 19/00533
USPC 375/240.12

(57) ABSTRACT

A moving image processing apparatus includes a storage unit to store encoding parameter information generated by encoding each of multiple blocks obtained by partitioning an image; a candidate list generation unit to generate a prediction vector candidate list including two prediction vector candidates for a motion vector of each of the blocks to be processed; a difference vector calculation unit to set one bit of predetermined information in selection information for the prediction vector candidates if inter-prediction is applied to the block to be processed, and to calculate a difference vector representing a difference between the motion vector of the block to be processed and one of the prediction vector candidates designated by the selection information; and a variable-length encoding unit to apply variable-length encoding to the encoding parameter information including the difference vector and the selection information.

### CROSS-REFERENCE TO RELATED APPLICATIONS

This application is based upon and claims the benefit of priority of the prior Japanese Priority Application No. 2013-147966 filed on Jul. 16, 2013, the entire contents of which are hereby incorporated by reference.

### FIELD

The disclosures herein generally relate to a moving image processing apparatus and a moving image processing method.

### BACKGROUND

In recent years, moving image encoding has achieved a high compression rate of images by partitioning an image into blocks, predicting pixels included in the blocks, and encoding prediction difference. A prediction mode that configures prediction pixels from pixels in a picture to be encoded is called “intra-prediction”, and a prediction mode that configures prediction pixels from a reference image encoded in the past is called “inter-prediction”.

Inter-prediction is also called “motion compensation”. In a moving image encoding apparatus, inter-prediction represents a region referred to as prediction pixels by a motion vector, which is two-dimensional coordinate data that has a horizontal (x) component and a vertical (y) component, and encodes prediction difference data between the motion vector and the pixels.

To suppress the code amount of a motion vector, a prediction vector (prediction value) is generated from a motion vector of a block adjacent to the block to be encoded, and a difference vector between the motion vector and the prediction vector is encoded.

Also in a moving image decoding apparatus, the same prediction vector is determined for each block as determined in the moving image encoding apparatus, to restore the motion vector by adding the encoded difference vector and the prediction vector. For this purpose, the moving image encoding apparatus and the moving image decoding apparatus include the same motion vector prediction unit.

In such a moving image decoding apparatus, blocks are generally decoded in an order from the upper left to the lower right of an image as done in raster scanning or z scanning. Therefore, motion vectors for prediction that can be used by the motion vector prediction unit of the moving image encoding apparatus and the moving image decoding apparatus are motion vectors in blocks adjacent at the left and above from the block to be processed because these blocks adjacent at the left and above have been decoded earlier in the moving image decoding apparatus.

Moreover, in MPEG-4 AVC/H.264, there are cases where a prediction vector is determined using a motion vector of a reference picture that has been encoded or decoded in the past instead of a picture to be processed (see, for example, Non-Patent Document 1).

As a technology of the prediction vector determination method, High Efficiency Video Coding (HEVC) has been investigated for standardization by cooperation of ISO/IEC and ITU-T, which are international standardization organizations (see, for example, Non-Patent Document 2). Also, HM Software (Version 8.0) is disclosed as reference software.

In the following, an overview of HEVC will be described as a moving image encoding technology. HEVC defines two lists of pictures (reference picture lists) that are called “L0” and “L1”.

Each block can use regions in up to two reference pictures for inter-prediction, depending on motion vectors corresponding to L0 and L1, respectively. L0 and L1 in general correspond to the direction of display time where L0 is a reference list of past pictures relative to a picture to be processed, and L1 is a reference list of future pictures relative to the picture to be processed.

Each entry in a reference picture list includes information about a stored position of the pixel data and display time information, or a POC (Picture Order Count) value, of the picture. The POC is an integer value that represents the display order and relative display time of the picture. Assuming that the display time is 0 for a picture having the POC value of 0, the display time of another picture can be represented by a constant multiple of the POC value of the other picture.

For example, assuming that the display cycle (Hz) of frames is fr, the display time of a picture having the POC value of p can be represented by the following formula (1). Thus, the POC can be regarded as the display time represented by a certain constant (in second) as the unit.

display time=p×(fr/2) formula (1)

If the number of entries in a reference picture list is greater than or equal to two, each motion vector specifies which one of the reference pictures to refer to by the index number (reference index) in the reference picture list.

If the number of entries in the reference picture list is one, the reference index does not need to be explicitly specified because the reference index of the motion vector that corresponds to the list is automatically set to 0. Namely, the motion vector of the block includes an L0/L1 list identifier, a reference index, and vector data (Vx, Vy). The L0/L1 list identifier and the reference index specifies a reference picture, and the vector data (Vx, Vy) specifies a region in the reference picture.

Vx and Vy are differences between the coordinates in the reference region and coordinates in the current block in the horizontal direction and the vertical direction, respectively, and represented by units of ¼ pixels. The L0/L1 list identifier together with the reference index is also called a “reference picture identifier”, and (Vx, Vy) is also called “vector data” below. A “unidirectional prediction” is a prediction that generates an inter-prediction image using one of the motion vectors in L0 and L1, and a “bidirectional prediction” uses both, which is also called a “bi-prediction”.

A determination method of a prediction vector in HEVC will be described. A prediction vector is determined for each reference picture specified by the L0/L1 list identifier and the reference index. When determining the vector data mvp of the prediction vector for a motion vector that refers to a reference picture specified by a reference picture list of LX (where X=0 or 1) and a reference index refidx, first, maximally three pieces of vector data are calculated as prediction vector candidates.

Blocks adjacent to a block to be processed in the space direction and in the time direction are classified into three groups that include blocks adjacent in the left, blocks adjacent in the above, and blocks adjacent in time, respectively.

Maximally one prediction vector candidate is selected from each of these three groups. The selected prediction vector candidates constitute a list with a priority order of the blocks adjacent in the left, the blocks adjacent in the above, and the blocks adjacent in time. The prediction vector candidate list is an array denoted as mvp_cand.

The maximum number of elements in the prediction vector candidate list is two. Therefore, if three prediction vector candidates are selected, one of the three prediction vector candidates having the lowest priority is discarded. If the number of prediction vector candidates is less than two, a zero vector is added to mvp_cand.

FIG. 1 is a schematic view illustrating an example of a prediction vector candidate list. In the example illustrated in FIG. 1, a prediction vector candidate of a block selected in the group of blocks adjacent in the above is mvp_cand[0]. Also, a prediction vector candidate of a block selected in the group of blocks adjacent in the left is mvp_cand[1].

Second, when selecting one of the prediction vector candidates in the prediction vector candidate list as the prediction vector, the prediction vector candidate index mvp_idx is used as the identifier of selection information for prediction vector candidates.

Namely, mvp is the vector data of a prediction vector candidate in mvp_cand located at the index mvp_idx.

In a moving image encoding apparatus, assuming that my is a motion vector referring to LX of the block to be encoded at refidx, a candidate closest to mv is searched for in mvp_cand, and the index of the found candidate is set as mvp_idx.

Moreover, a difference vector mvd is calculated by the following formula (2), and then, refidx, mvd, and mvp_idx are encoded as motion vector information of the list LX to be transmitted to a moving image decoding apparatus.

mvd=mv−mvp formula (2)

The moving image decoding apparatus decodes refidx, mvd, and mvp_idx, determines mvp_cand based on refidx, and sets the prediction vector mvp as the prediction vector candidate in mvp_cand located at the index mvp_idx. The motion vector my of the block to be processed is restored by the following formula (3).

mv=mvd+mvp formula (3)

On the other hand, technologies are known that embed watermark information and/or information related to moving images into moving image data to be compressed and encoded. For example, the following technology is known for embedment of information using motion vectors. An encoding device that embeds electronic watermark information first obtains an optimal motion vector by units of pixels. The encoding device takes one bit out of the electronic watermark information, and depending on the value (0 or 1) of the bit, restricts the search range for a new motion vector by units of half pixels. Next, the encoding device obtains a pixel closest to the original pixel from eight half pixels (half pels) that surround a reference pixel designated by the optimal motion vector obtained by units of pixels, and sets the vector designating the obtained pixel as the new motion vector. A decoding device for taking out the electronic watermark information decodes the motion vector, detects whether the x component and y component of the motion vector are set by units of half pixels, and calculates the watermark information by a combination of the x component and y component (see, for example, Non-Patent Document 3).

In contrast to Non-Patent Document 3 above, there is a technology that increases the degrees of freedom for keeping picture quality when embedding information by using a motion vector, and at the same time, extracts the information even if the method of embedding the information is changed (see, for example, Patent Document 1).

### RELATED-ART DOCUMENTS

### Non-Patent Document

[Non-Patent Document 1] ISO/IEC 14496-10 (MPEG-4 Part 10) / ITU-T Rec.H.264

[Non-Patent Document 2] Thomas Wiegand, Woo-Jin Han, Benjamin Bross, Jens-Rainer Ohm, Gary J. Sullivan, “Working Draft 8 of High-Efficiency Video Coding” JCTVC-J1003, 2012-07 Stockholm

[Non-Patent Document 3] H. Nakazawa, R. Kodate, H. Tominaga, “A Study on Digital Watermarking on MPEG2 for Copyright Protection”, Proceedings of the 1997 IEICE General Conference, March 1997, IEICE

### Patent Documents

[Patent Document 1] Japanese Laid-open Patent Publication No. 2008-259059

Conventional embedment technologies have a problem in that when embedding watermark information into moving image data that has been already compressed and encoded, error differences are generated in a decoded image of the compressed moving image data before and after the embedment when performing the embedment just by operating motion vector values. Namely, the problem is that the picture quality of a decoded image is degraded after the embedment.

A decoded image is calculated as a sum of an inter-prediction image and a prediction difference. Therefore, if the motion vector is changed, error differences are generated in the decoded image because a reference region that is different from the original motion vector is used as the inter-prediction image.

Moreover, if information is embedded in each picture, picture quality degradation due to information embedment is accumulated with inter-prediction, which makes the picture quality degradation greater. This is because if error differences are generated in a reference image, the error differences are propagated to a picture to be processed because inter-prediction of moving image data that has been already compressed is obtained by compressing decoded pixels before embedment as a reference image.

Such degradation due to error differences generated in a reference image and accumulated by inter-prediction is called a “drift error”. To avoid such picture quality degradation of a decoded image due to embedment and/or a drift error, it is necessary to decode compressed moving image data and to encoded it again.

Namely, a detection process of a motion vector and/or an embedment operation of information are applied to a decoded image obtained by a decoding process, and then, an encoding process is applied again to the moving image using a region, which is referred to by the motion vector obtained after the embedment operation, as an inter-prediction image.

For example, when distributing moving image data to multiple users, if the moving image data to be distributed is embedded with user specific information such as a user ID, a moving image compression process is required for each user, which makes the amount of calculation considerably greater if the number of users gets greater.

Therefore, conventional technologies have a problem that information cannot be embedded in compressed moving image data without increasing the amount of calculation and degradation of picture quality.

### SUMMARY

According to at least one embodiment of the present invention, a moving image processing apparatus includes a storage unit to store encoding parameter information generated by encoding each of multiple blocks obtained by partitioning an image; a candidate list generation unit to generate a prediction vector candidate list including two prediction vector candidates for a motion vector of each of the blocks to be processed; a difference vector calculation unit to set one bit of predetermined information in selection information for the prediction vector candidates if inter-prediction is applied to the block to be processed, and to calculate a difference vector representing a difference between the motion vector of the block to be processed and one of the prediction vector candidates designated by the selection information; and a variable-length encoding unit to apply variable-length encoding to the encoding parameter information including the difference vector and the selection information.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a prediction vector candidate list;

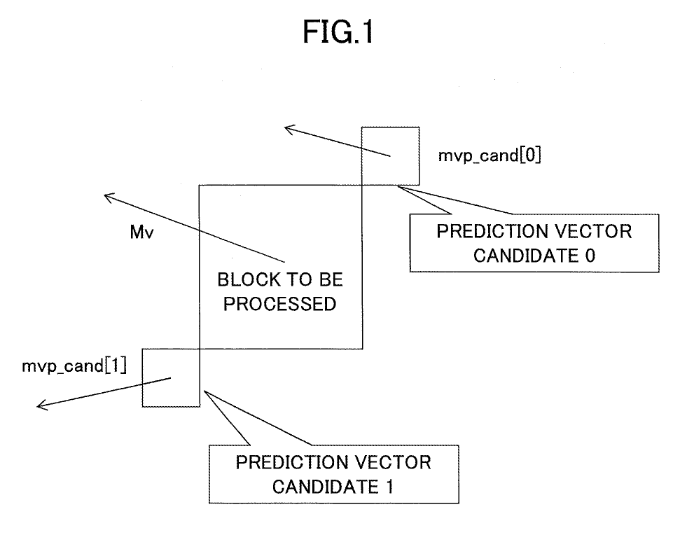

FIG. 2 is a schematic view illustrating an image processing system 1 according to embodiments of the present invention;

FIG. 3 is a block diagram illustrating an example of a configuration of a moving image processing apparatus according to a first embodiment;

FIG. 4 is a flowchart illustrating an example of moving image processing according to the first embodiment;

FIG. 5 is a block diagram illustrating an example of a configuration of a moving image processing apparatus according to a second embodiment;

FIG. 6 is a block diagram illustrating an example of a configuration of a determination unit according to the second embodiment;

FIG. 7 is a flowchart illustrating an example of a second embedment determination process according to the second embodiment;

FIG. 8 is a block diagram illustrating an example of a configuration of a moving image decoding apparatus according to a third embodiment;

FIG. 9 is a flowchart illustrating an example of moving image processing according to the third embodiment;

FIG. 10 is a block diagram illustrating an example of a configuration of a moving image processing apparatus according to a first modified example; and

FIG. 11 is a block diagram illustrating an example of a configuration of a moving image processing apparatus according to a second modified example.

### DESCRIPTION OF EMBODIMENTS

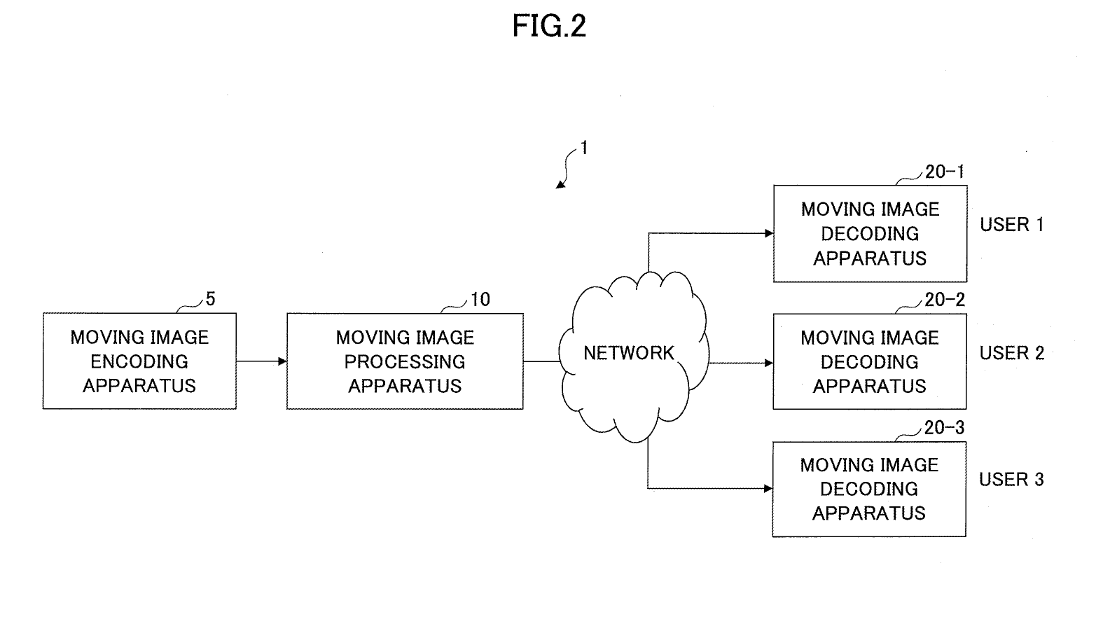

In the following, embodiments of the present invention will be described with reference to the drawings. First, an image processing system 1 will be described according to embodiments of the present invention. FIG. 2 is a schematic view illustrating the image processing system 1 according to the embodiments of the present invention. As illustrated FIG. 2, the image processing system 1 includes a moving image encoding apparatus 5, a moving image processing apparatus 10, and moving image decoding apparatuses 20.

The moving image encoding apparatus 5 applies an encoding process to a moving image using an encoding technology of, for example, HEVC. The encoded moving image data (bit stream) is output to the moving image processing apparatus 10.

The moving image processing apparatus 10 obtains the moving image data, and embeds predetermined information into the moving image data. The predetermined information is embedment information that represents specific information such as a user ID. The moving image processing apparatus also functions as an embedment apparatus for embedding the predetermined information into the moving image data.

When embedding, for example, a user ID into the moving image data, the moving image processing apparatus 10 applies an embedment process to the moving image data for each user ID, and outputs the moving image data via a network to the moving image decoding apparatus 20 corresponding to the user. The moving image processing apparatus 10 can embed the information without increasing the amount of calculation and causing degradation of picture quality as will be described below. Note that the moving image processing apparatus 10 may be built in the moving image encoding apparatus 5.

The moving image decoding apparatuses 20 correspond to users. For example, user 1 has the moving image decoding apparatus 20-1, user 2 has the moving image decoding apparatus 20-2, and user 3 has the moving image decoding apparatus 20-3. The moving image decoding apparatuses 20-1 to 20-3 have the same function, and will be generically denoted as the moving image decoding apparatus 20 if no distinctions are required for the individual apparatuses.

In response to receiving the moving image data, the moving image decoding apparatus 20 decodes the moving image data, and detects the predetermined information that has been embedded. Also, the moving image decoding apparatus 20 together with the moving image encoding apparatus 5 is also called the “moving image processing apparatus”.

### First Embodiment

Next, a moving image processing apparatus 10 will be described according to the first embodiment. The moving image processing apparatus 10 in the first embodiment is denoted with a numerical code 10A.

<Configuration>

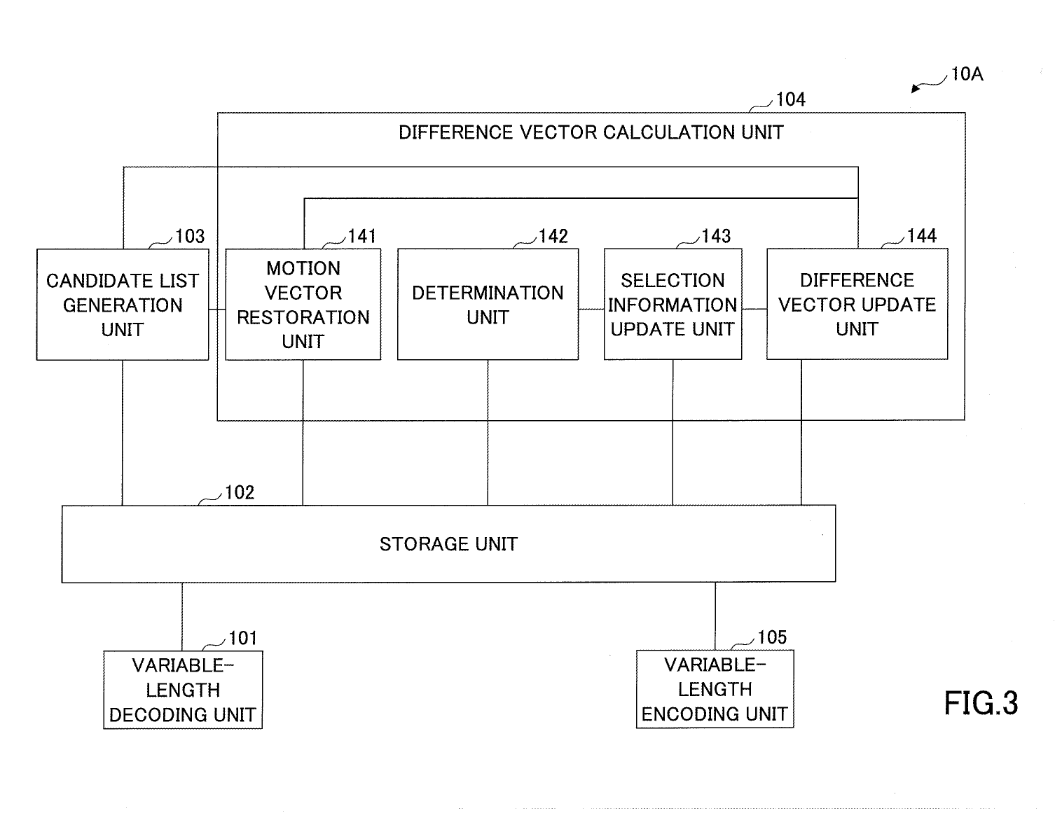

FIG. 3 is a block diagram illustrating an example of a configuration of the moving image processing apparatus 10A according to the first embodiment. In the example illustrated in FIG. 3, the moving image processing apparatus 10A includes a variable-length decoding unit 101, a storage unit 102, a candidate list generation unit 103, a difference vector calculation unit 104, and a variable-length encoding unit 105. These units are connected with each other for data communication.

The variable-length decoding unit 101 receives moving image data transmitted from the moving image encoding apparatus 5, and applies a decoding process to the moving image data. With the decoding process, encoding parameter information of a block to be processed is decoded.

The variable-length decoding unit 101 decodes a prediction mode that designates either of intra or inter prediction, a reference index, a difference vector, and a prediction candidate index of L0, a reference index, a difference vector, a prediction candidate index of L1, an orthogonal transformation coefficient, and the like. The decoded information is also called the “encoding parameter information”.

The storage unit 102 stores the encoding parameter information decoded by the variable-length decoding unit 101. Namely, for an image partitioned into multiple blocks, the storage unit 102 encodes the image by units of blocks, and stores the generated encoding parameter information for each of the blocks.

For each of the block to be processed, the candidate list generation unit 103 generates a prediction vector candidate list that includes two prediction vector candidates for a motion vector of the block. Based on the reference index of decoded LX (where X=0 or 1), the candidate list generation unit 103 calculates a candidate list mvp_cand of prediction vectors for LX.

An example of a method of generating the candidate list of prediction vectors is to generate motion vectors from the block adjacent in the left, the block adjacent in the above, and a block adjacent in time, which is similar to the prediction vector candidate list generation method of HEVC. Here, similarly to HEVC, it is assumed that the number of elements in mvp_cand is two, and prediction vector candidates are generated accordingly. Therefore, mvp idx is either 0 or 1.

The candidate list generation unit 103 outputs the generated prediction vector candidate list to the motion vector restoration unit 141 and the difference vector update unit 144.

If the block to be processed is for inter-prediction, the difference vector calculation unit 104 sets one bit of the predetermined information to selection information (mvp_idx) for the prediction vector candidates. Also, the difference vector calculation unit 104 calculates a difference vector between the motion vector of the block to be processed and the prediction vector candidate designated by the selection information.

To calculate the difference vector, the difference vector calculation unit 104 also includes a motion vector restoration unit 141, a determination unit 142, a selection information update unit 143, and a difference vector update unit 144.

The motion vector restoration unit 141 obtains the prediction vector candidate list generated by the candidate list generation unit 103;

the selection information for the prediction vector candidates included in the encoding parameter information stored in the storage unit 102; and the difference vector, and restores the motion vector of the block to be processed.

The motion vector restoration unit 141 obtains, for example, the LX prediction candidate index mvp_idx (selection information) decoded by the variable-length decoding unit 101 and the difference vector mvd. The motion vector restoration unit 141 calculates the prediction vector mvp by mvp=mvp_cand[mvp_idx], which specifies an element in the prediction vector candidate list by the prediction candidate index. The motion vector restoration unit 141 adds the difference vector mvd and the prediction vector mvp (formula (3)) to restore the motion vector of LX.

The restored reference index and motion vector of LX are held in the storage unit 102, and are used for processing succeeding blocks. The motion vector restoration unit 141 outputs the restored motion vector to the difference vector update unit 144.

Using the encoding parameter information stored in the storage unit 102, the determination unit 142 determines whether the block to be processed is a block having inter-prediction applied, and based on the determination, further determines whether the block to be processed is a block to be embedded with the predetermined information. For example, the determination unit 142 determines whether embedment information can be embedded into the selection information mvp_idx of the prediction vector of LX of the block to be processed.

If the block to be processed has intra-prediction applied, the determination unit 142 determines that embedment is not possible because mvp_idx of LX is not to be encoded. If the prediction mode is an inter-prediction mode only with L0, the determination unit 142 determines that embedment cannot be made into mvp_idx of L1.

Moreover, if the prediction mode is a prediction mode only with L1, the determination unit 142 determines that embedment cannot be made into mvp_idx of L0. Also, for the inter-prediction mode, if the number of elements in mvp_cand is one, embedment cannot be made because mvp_idx is fixed to 0. In this case, the determination unit 142 also determines that embedment cannot be made.

Also, the determination unit 142 may always determine that embedment cannot be made into one of L0 and L1 so that embedment is made into the other of L0 and L1. Also, the determination unit 142 may determine that embedment cannot be made using predetermined criteria that depend on the position of a block to be processed in the image. The predetermined criteria may define positions of blocks to which embedment is applied. For example, embedment is applied to blocks at intervals, or to blocks at an upper right region in the image. This makes security improved because the predetermined information cannot be detected if the predetermined criteria is unknown at a detection side.

If embedment can be applied to the block to be processed, the determination unit 142 indicates it to the selection information update unit 143.

If the block to be processed is to be processed with embedment, the selection information update unit 143 updates the selection information for the prediction vector candidates included in the encoding parameter information stored in the storage unit 102 based on the predetermined information.

For example, if determining that embedment can be made into mvp_idx of LX, the selection information update unit 143 changes the prediction vector candidate index mvp_idx based on the predetermined information to be embedded next. Namely, the selection information update unit 143 takes a next bit to be embedded from the predetermined information, and sets mvp_idx=y where y (y=0 or 1) is the value of the next bit. The selection information update unit 143 outputs the update selection information to the difference vector update unit 144.

The difference vector update unit 144 calculates a difference vector between a prediction vector candidate, which is designated by the update selection information included in the prediction vector candidate list, and the restored motion vector. The difference vector update unit 144 replaces a difference vector included in the encoding parameter information stored in the storage unit 102 with the calculated difference vector.

For example, the difference vector update unit 144 selects a prediction vector based on the changed selection information mvp_idx, and calculates the difference vector mvd with the motion vector restored at the motion vector restoration unit 141 using the following formula (4). In this way, the difference vector mvd in the storage unit 102 is changed.

mvd=mv−mvp_cand[mvp_idx]

formula (4)
The difference vector update unit 144 stores the updated difference vector in the storage unit 102.

The variable-length encoding unit 105 applies variable-length encoding to the block to be processed based on the updated encoding parameter information, and generates and outputs the moving image data. Thus, processing of the block to be processed is completed, and then, a next block will be processed.

Configured as above, the moving image processing apparatus 10A embeds the predetermined information into the selection information for the prediction vector candidates for encoded moving image data. Thus, embedment can be made without increasing the amount of calculation and causing degradation of picture quality because an image as a whole does not need to decoded and encoded again.

<Operations>

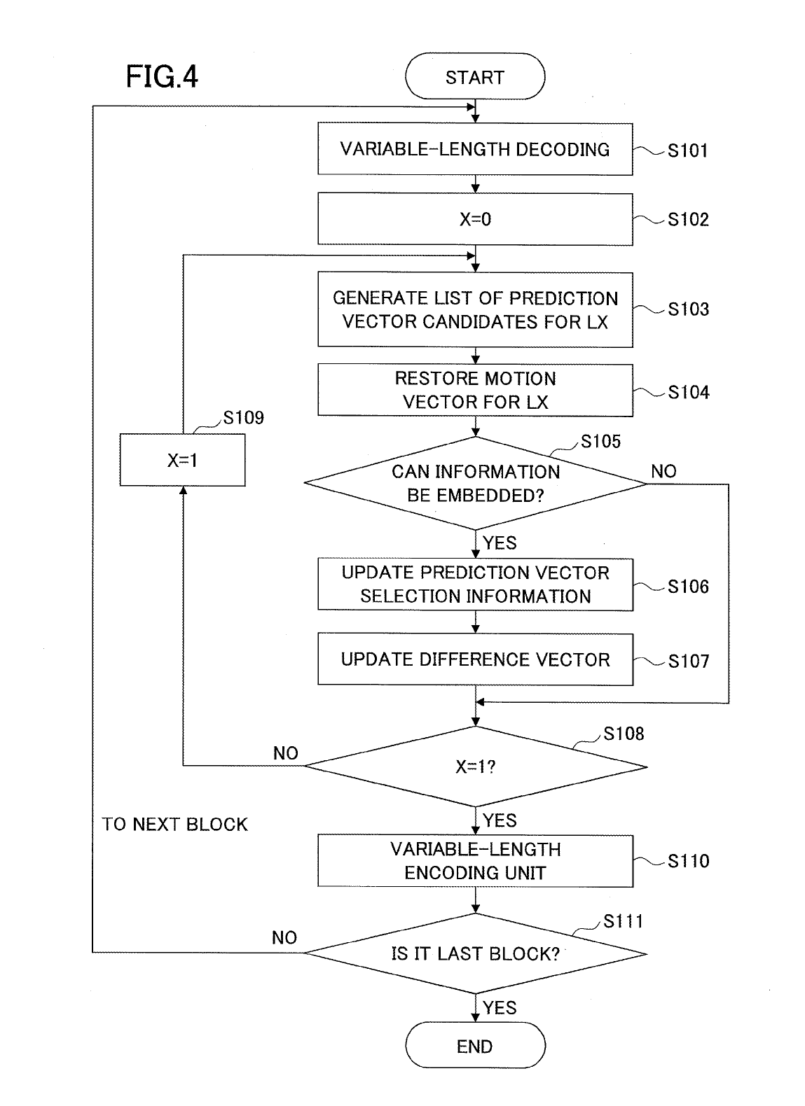

Next, operations of the moving image processing apparatus 10A will be described. FIG. 4 is a flowchart illustrating an example of an example of moving image processing according to the first embodiment. In the process in FIG. 4, an example is illustrated where predetermined information is embedded into encoded moving image data.

At Step S101, the variable-length decoding unit 101 applies variable-length decoding to the encoded moving image data (compressed stream data).

At Step S102, the moving image processing apparatus 10A sets 0 to X to specify one of the reference picture lists.

At Step S103, the candidate list generation unit 103 generates a prediction vector candidate list for the reference picture list LX.

At Step S104, the motion vector restoration unit 141 restores a motion vector of the reference picture list LX using formula (3).

At Step S105, the determination unit 142 determines whether a block to be processed can have predetermined information embedded. The determination unit 142 determines that embedment can be made if the prediction mode is, for example, inter-prediction. If the embedment can be made (YES at Step S105), the process goes forward to Step S106, or if the embedment cannot be made (NO at Step S105), the process goes forward to Step S108.

At Step S106, the selection information update unit 143 updates the selection information for the prediction vector candidates based on the predetermined information of the embedment target.

At Step S107, the difference vector update unit 144 updates the difference vector using the prediction vector candidate designated by the updated selection information and the restored motion vector.

At Step S108, the moving image processing apparatus 10A determines whether X of the reference picture list is 1. If X is 1 (YES at Step S108), the process goes forward to Step S110, or if X is 0 (NO at Step S108), the process goes forward to Step S109.

At Step S109, the moving image processing apparatus 10A sets 1 to X of the reference picture list, and the process goes back to Step S103.

At Step S110, the variable-length encoding unit 105 applies variable-length encoding to the updated encoding parameter information.

At Step S111, the moving image processing apparatus 10A determines whether the block to be processed is the last block. If the block to be processed is the last block (YES at Step S111), the process ends, or if the block to be processed is not the last block (NO at Step S111), the process goes back to Step S101.

As described above, according to the first embodiment, embedment can be made without increasing the amount of calculation and causing degradation of picture quality when embedding predetermined information into encoded moving image data.

### Second Embodiment

In the first embodiment, mvp_idx of input moving image data is changed based on predetermined information (embedment information). Therefore, the moving image processing apparatus 10A in the first embodiment controls that a motion vector to be decoded is not changed before and after embedment, by changing the difference vector mvd of the input moving image data. However, there is likelihood in that the code amount for mvd increases because mvd is changed.

Thereupon, in the second embodiment, to prevent the code amount of mvd from increasing, a determination unit may make determination for controlling that the increased code amount of mvd is contained within a certain range. The moving image processing apparatus 10 in the second embodiment is denoted with a numerical code 10B.

<Configuration>

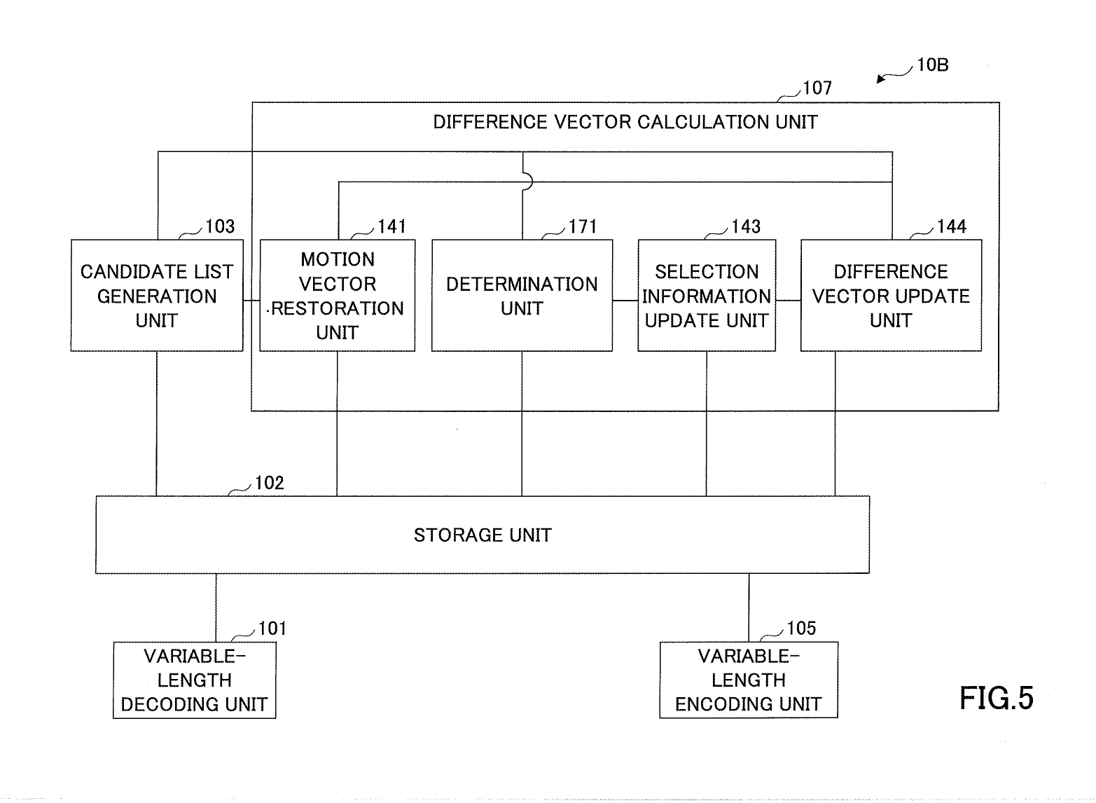

FIG. 5 is a block diagram illustrating an example of a configuration of the moving image processing apparatus 10B according to the second embodiment. In the configuration in FIG. 5, the same elements as in the first embodiment (the elements in FIG. 3) are assigned the same numeral codes. In the following, elements that differ from those in the first embodiment will be mainly described.

The candidate list generation unit 103 outputs generated prediction vector candidates to the determination unit 171 of the difference vector calculation unit 107 and the difference vector update unit 144.

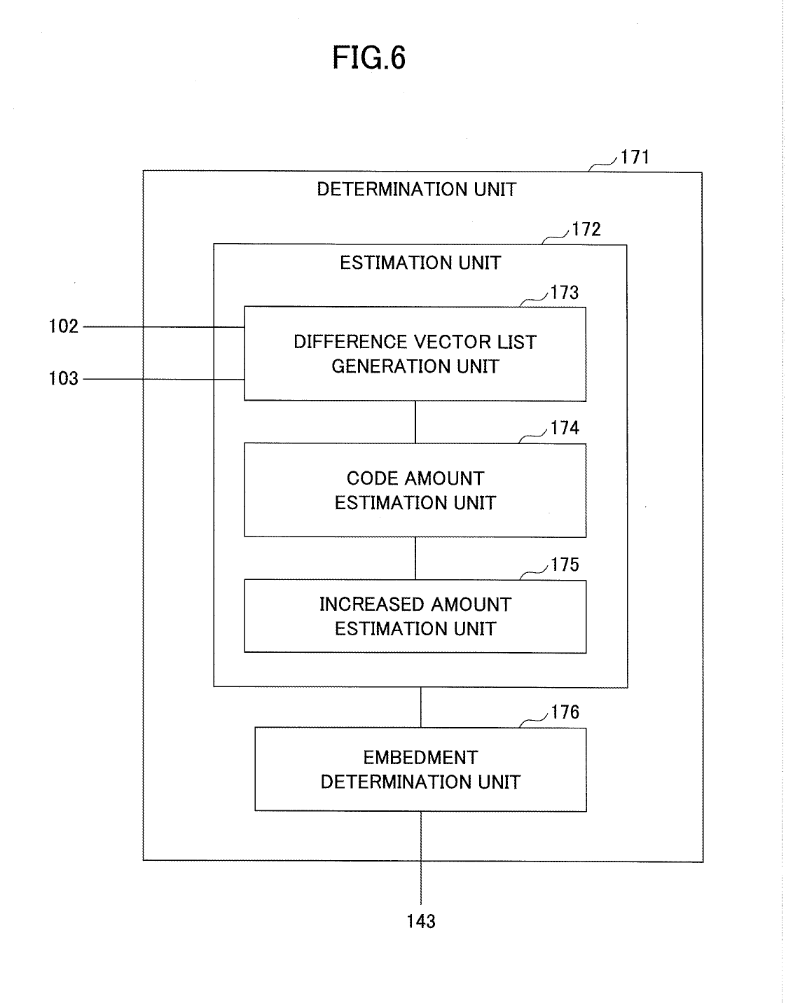

The determination unit 171 determines a block to have embedment applied, in addition to the determination as done in the first embodiment, so that increase of the code amount is suppressed. Details of the determination unit 171 will be described using FIG. 6.

FIG. 6 is a block diagram illustrating an example of a configuration of the determination unit 171. The determination unit 171 illustrated in FIG. includes an estimation unit 172 and an embedment determination unit 176.

The estimation unit 172 estimates an increased code amount if the selection information for the prediction vector candidates is updated. The estimation unit 172 outputs the estimated increased code amount to the embedment determination unit 176.

Also, the estimation unit 172 includes a difference vector list generation unit 173, a code amount estimation unit 174, and an increased amount estimation unit 175.

The difference vector list generation unit 173 generates a difference vector list that includes prediction vector candidates included in a prediction vector candidate list of the block to be processed and difference vectors calculated from a motion vector.

For example, the difference vector list generation unit 173 obtains the prediction vector candidate list mvp_cand from the candidate list generation unit 103, and a motion vector my from the storage unit 102. For all prediction candidates of mvp_cand, the difference vector list generation unit 173 calculates the list mvd_cand of difference vectors mvd by formula (2).

Note that mvp_cand[i] correspond to mvd_cand[i], and mvd_cand[i]=mv-mvp_cand[i]. The difference vector list generation unit 173 outputs the generated difference vector list to the code amount estimation unit 174.

The code amount estimation unit 174 calculates an estimation value of the code amount for each difference vector included in the difference vector list.

For example, the code amount estimation unit 174 estimates the code amount for each element in mvd_cand as a difference vector assuming it is encoded. As an encoding method of mvd, a method that applies exponential-Golomb coding to the horizontal component and the vertical component of mvd, respectively, a method that applies arithmetic coding to a bit string obtained with the exponential-Golomb coding, or the like may be used.

The estimation value of the code amount may be a code amount obtained with actual encoding, or may be a prediction value. If using the code amount obtained with actual encoding, the code amount estimation unit 174 can precisely control the increase of the code amount.

As an example of the prediction value, the length of mvd_cand[i] may be used as the prediction value because a difference vector is two-dimensional data. Namely, the prediction value is the sum of absolute values of the x component and y component of mvd_cand[i].

In the following, a list of estimation values of code amounts is denoted as mvdlen_cand. mvd_cand[i] corresponds to mvdlen_cand[i]. The code amount estimation unit 174 outputs the list mvdlen_cand of estimation values to the increased amount estimation unit 175.

The increased amount estimation unit 175 calculates a difference between a maximum value and a minimum value among estimation values of all difference vectors included in the difference vector list, and sets the difference as the increased code amount.

For example, the increased amount estimation unit 175 first calculates the maximum value and the minimum value of mvdlen_cand[i]. The increased amount estimation unit 175 sets the maximum value and the minimum value to mvdlen_max and mvdlen_min, respectively, sets mvdlen_max-mvdlen_min as the increased code amount, and outputs it to the embedment determination unit 176.

The embedment determination unit 176 determines whether the block to be processed is a block to have embedment applied based on the estimated increased code amount. If determining that it is a block to have embedment applied, the embedment determination unit 176 outputs it to the selection information update unit 143.

For example, the embedment determination unit 176 determines that embedment cannot be made if the increased code amount (=mvdlen_max-mvdlen_min)≧C where C is a predetermined threshold value for controlling increase of the code amount.

Thus, if the estimation method of the code amount is precise enough, the increased code amount of mvd caused when mvp_idx is changed with information embedment can be guaranteed less than C in a worst case. Also, if the estimation method of the code amount is based on prediction values, the increased code amount of mvd can be suppressed. The threshold value C may be a fixed value, or may be dynamically changed based on a degree of the increased code amount for blocks processed in the past for information embedment.

<Operations>

Next, operations of the moving image processing apparatus 10B will be described according to the second embodiment. Moving image processing in the second embodiment is basically the same as the moving image processing in the first embodiment, although a second embedment determination is executed between Steps S105 and S106. Therefore, the second embedment determination process in the second embodiment will be described in the following.

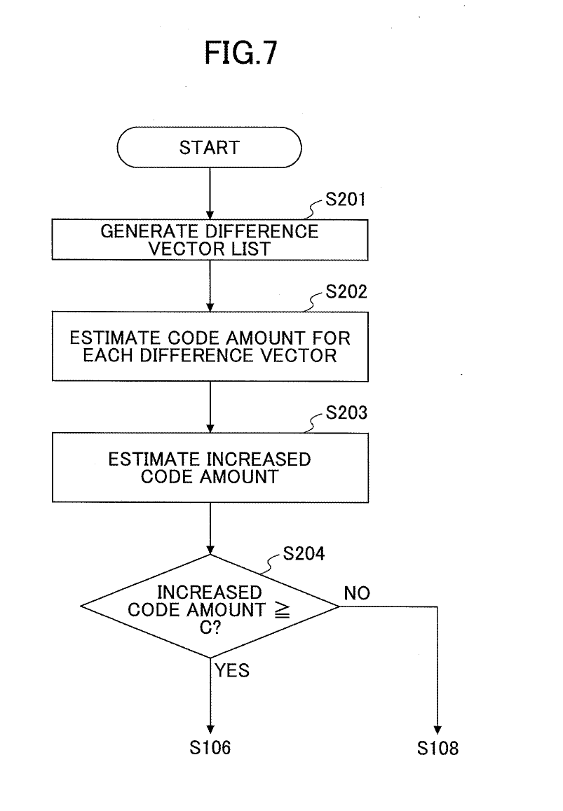

FIG. 7 is a flowchart illustrating an example of the second embedment determination process according to the second embodiment. At Step S201 in FIG. 7, the difference vector list generation unit 173 generates a difference vector list that includes prediction vector candidates included in a prediction vector candidate list of the block to be processed and difference vectors calculated from a motion vector.

At Step S202, the code amount estimation unit 174 calculates an estimation value of the code amount for each difference vector included in the difference vector list

At Step S203, the increased amount estimation unit 175 calculates a difference between a maximum value and a minimum value among estimation values of all difference vectors included in the difference vector list, and sets the difference as the increased code amount.

At Step S204, the embedment determination unit 176 determines whether the estimated increased code amount is greater than or equal to the predetermined threshold value C. If the increased code amount ≧C (YES at Step S204), the process goes forward to Step S106, or if the increased code amount <C (NO at Step S204), the process goes forward to Step S108.

As described above, according to the second embodiment, embedment can be made without increasing the amount of calculation and causing degradation of picture quality when embedding predetermined information into encoded moving image data.

### Third Embodiment

Next, a moving image decoding apparatus will be described according to the third embodiment. In the third embodiment, predetermined information embedded using the first embodiment or the second embodiment can be detected.

<Configuration>

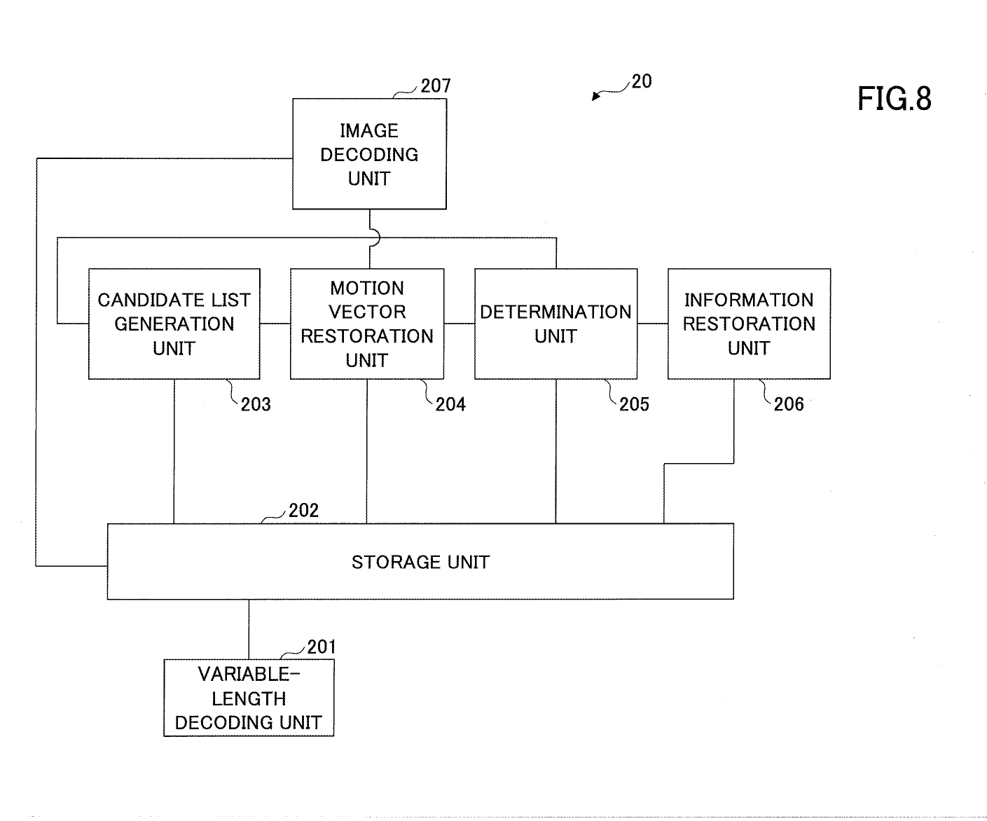

FIG. 8 is a block diagram illustrating an example of a configuration of a moving image decoding apparatus 20 according to the third embodiment. The moving image decoding apparatus 20 illustrated in FIG. 8 includes a variable-length decoding unit 201, a storage unit 202, a candidate list generation unit 203, a motion vector restoration unit 204, a determination unit 205, an information restoration unit 206, and an image decoding unit 207.

The variable-length decoding unit 201 applies variable-length decoding to moving image data encoded by units of blocks, and obtains decoded encoding parameter information. The variable-length decoding unit 201 stores the decoded encoding parameter information in the storage unit 202.

The storage unit 202 stores the encoding parameter information decoded by the variable-length decoding unit 201.

The candidate list generation unit 203 generates a prediction vector candidate list that includes two prediction vector candidates for the motion vector of the block.

The motion vector restoration unit 204 obtains the prediction vector candidate list generated by the candidate list generation unit 203, the selection information for the prediction vector candidates included in the encoding parameter information stored in the storage unit 202, and the difference vector. The motion vector restoration unit 204 adds the prediction vector candidate designated by the selection information and the difference vector, to restore the motion vector.

The determination unit 205 determines whether the block to be processed is a block having inter-prediction applied, and based on the determination, further determines whether the block to be processed is a block having the predetermined information embedded. If the predetermined information has been embedded by the first embodiment, the determination unit 205 executes the determination in the same way as the determination unit 142 in the first embodiment, or if the predetermined information has been embedded by the second embodiment, the determination unit 205 executes the determination in the same way as the determination unit 171 in the second embodiment. Therefore, if it is assumed that the predetermined information has been embedded by the second embodiment, the determination unit 205 has the configuration illustrated in FIG. 6. The determination unit 205 outputs the determination result to the information restoration unit 206.

If the block to be processed is a block having the predetermined information embedded, the information restoration unit 206 restores the predetermined information from selection information for the prediction vector candidates in the block to be processed included in the encoding parameter information stored in the storage unit 202.

For example, if indicated from the determination unit 205 that the block has the predetermined information embedded, the information restoration unit 206 obtains the value x of the selection information mvp_idx for the prediction vector candidates from the storage unit 202, and outputs the value as the embedment information.

The image decoding unit 207 decodes the image by executing motion compensation using the motion vector restored by the motion vector restoration unit 204, executing inverse quantization, and/or executing inverse frequency transformation. It is sufficient for the image decoding unit 207 to be capable of executing a decoding process that is compatible with, for example, HEVC.

In this way, predetermined information embedded by the moving image processing apparatus in the first or second embodiment can be detected.

<Operations>

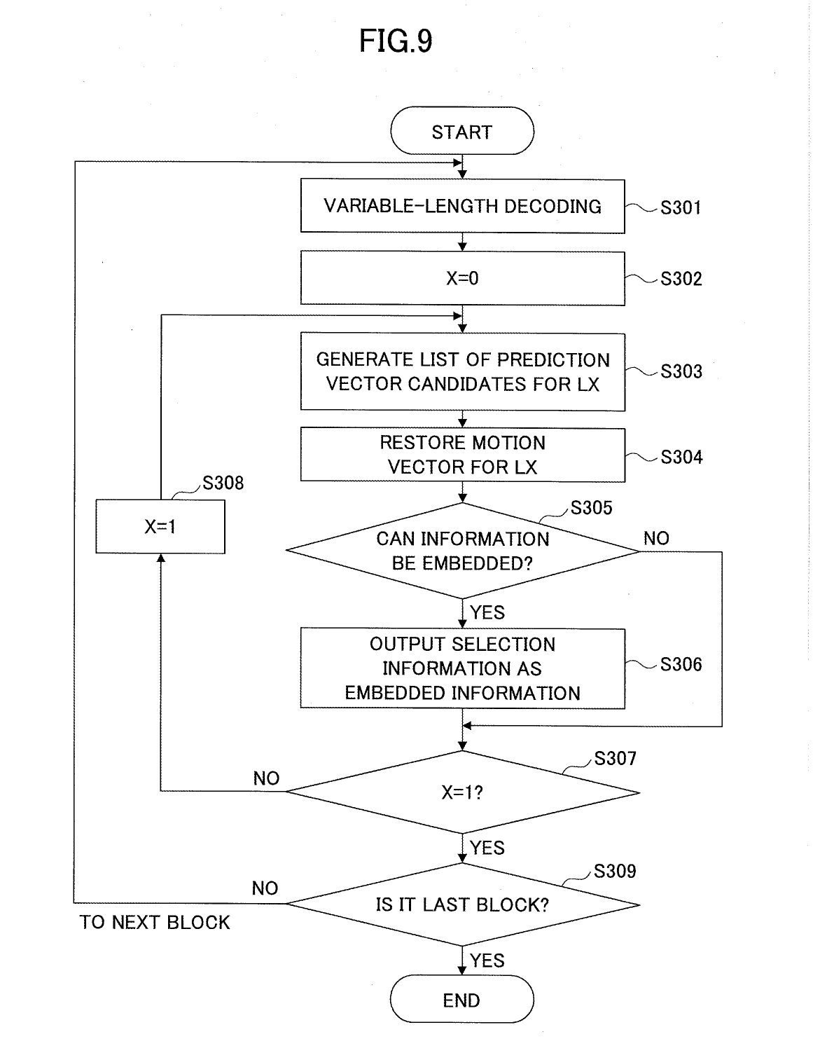

Next, operations of the moving image decoding apparatus 20 will be described according to the third embodiment. FIG. 9 is a flowchart illustrating an example of moving image processing according to the third embodiment. In the process illustrated in FIG. 9, an example is illustrated where moving image data having predetermined information embedded is decoded while the predetermined information is detected. Also, the process in FIG. 9 is a process for moving image data having predetermined information embedded by the moving image processing apparatus 10A in the first embodiment.

At Step S301, the variable-length decoding unit 201 applies variable-length decoding to the encoded moving image data (compressed stream data).

At Step S302, the moving image decoding apparatus 20 sets 0 to X to specify one of the reference picture lists.

At Step S303, the candidate list generation unit 203 generates a prediction vector candidate list of the reference picture list LX.

At Step S304, the motion vector restoration unit 204 restores a motion vector of the reference picture list LX using formula (3).

At Step S305, the determination unit 205 determines whether a block to be processed has the predetermined information embedded. The determination unit 205 determines that the predetermined information has been embedded if the prediction mode is, for example, inter-prediction.

If the predetermined information has been embedded (YES at Step S305), the process goes forward to Step S306, or if the predetermined information has not been embedded (NO at Step S305), the process goes forward to Step S307.

At Step S306, the information restoration unit 206 restores the predetermined information from the selection information for the prediction vector candidates of the block to be processed included in the encoding parameter information stored in the storage unit 202 if it is determined that the block to be processed has the predetermined information embedded.

At Step S307, the moving image decoding apparatus 20 determines whether X of the reference picture list is 1. If X is 1 (YES at Step S307), the process goes forward to Step S309, or if X is 0 (NO at Step S307), the process goes forward to Step S308.

At Step S308, the moving image decoding apparatus 20 sets 1 to X of the reference picture list, and the process goes back to Step S303.

At Step S309, the moving image decoding apparatus 20 determines whether the block to be processed is the last block. If the block to be processed is the last block (YES at Step S309), the process ends, or if the block to be processed is not the last block (NO at Step S309), the process goes back to Step S301.

Note that if the moving image data processed in the process in FIG. 9 has the predetermined information embedded by the moving image processing apparatus 10B in the second embodiment, the process illustrated in FIG. 7 is added between Steps S305 and S306. In this case, Step S106 in FIG. 7 is replaced with Step S306 in FIG. 9, and Step S108 in FIG. 7 is replaced with Step S307 in FIG. 9.

According to the third embodiment described as above, predetermined information embedded by the moving image processing apparatus in the first embodiment or the second embodiment can be detected without causing degradation of picture quality.

### First Modified Example

Next, a moving image processing apparatus will be described that combines one of the moving image processing apparatuses 10 according to the above embodiments with the moving image encoding apparatus 5. The moving image processing apparatus in the first modified example is denoted with a numerical code 10C.

<Configuration>

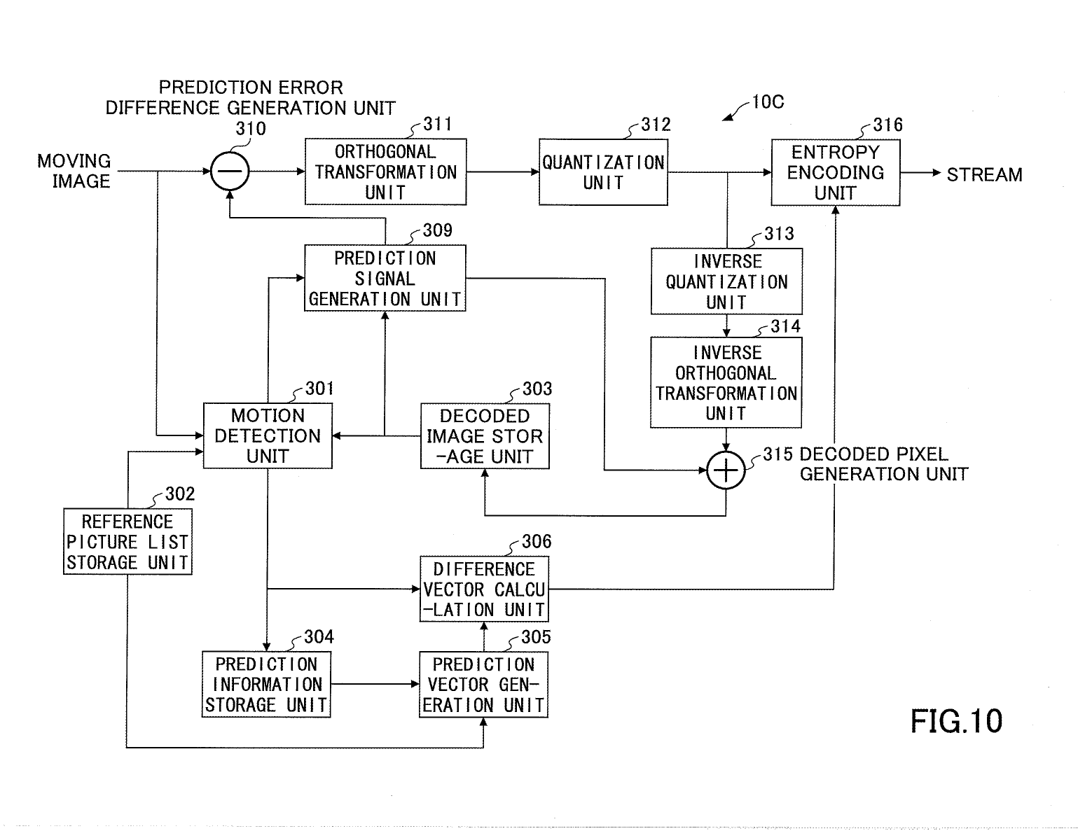

FIG. 10 is a block diagram illustrating an example of a configuration of the moving image processing apparatus 10C according to the first modified example. The moving image processing apparatus 10C illustrated in FIG. 10 includes a motion detection unit 301, a reference picture list storage unit 302, a decoded image storage unit 303, a prediction information storage unit 304, a prediction vector generation unit 305, and a difference vector calculation unit 306.

Also, the moving image processing apparatus 10C includes a prediction signal generation unit 309, a prediction error difference generation unit 310, an orthogonal transformation unit 311, a quantization unit 312, an inverse quantization unit 313, an inverse orthogonal transformation unit 314, a decoded pixel generation unit 315, and an entropy encoding unit 316.

The motion detection unit 301 obtains an original image, obtains the stored position of a reference picture from the reference picture list storage unit 302, and obtains the pixel data of the reference picture from the decoded image storage unit 303. The motion detection unit 301 detects prediction flags of L0 and L1, a reference index, and a motion vector. The motion detection unit 301 outputs the region position information of the reference image, which is referred to by the detected motion vector, to the prediction signal generation unit 309.

The reference picture list storage unit 302 stores the stored position of the reference picture and picture information including POC information of pictures that can be referred to by a block to be processed.

The decoded image storage unit 303 stores a picture that has encoding applied in the past, and has local decoding applied in the moving image encoding apparatus to use it as a reference picture for motion compensation.

The prediction information storage unit 304 stores motion vector information that includes the motion vector detected at the motion detection unit 301, the prediction flags of L0 and L1, and the reference index information. For a block to be processed, for example, the prediction information storage unit 304 stores motion vector information that includes motion vectors of spatially and temporally adjacent blocks, and reference picture identifiers designating pictures referred to by the motion vectors. The reference picture list storage unit 302 and the prediction information storage unit 304 correspond to the storage unit 102.

The prediction vector generation unit 305 generates prediction vector candidate lists of L0 and L1 using the prediction flags of L0 and L1 and the reference indices. The prediction vector generation unit 305 corresponds to the candidate list generation unit 103. The process for generating prediction vector candidates may be the same as a conventional process of, for example, HEVC described in Non-Patent Document 2.

The difference vector calculation unit 306 obtains motion vectors of L0 and L1 from the motion detection unit 301, obtains the prediction flags, reference indices, and prediction vector candidate lists of L0 and L1 from the prediction vector generation unit 305, and calculates respective difference vectors.

For example, the difference vector calculation unit 306 sets one bit of the predetermined information to be embedded into the selection information for the prediction vector candidates, and selects prediction vectors designated by the selection information in the respective prediction vector candidate lists. The difference vector calculation unit 306 determines the selected prediction vectors and the prediction vector candidate index, respectively.

Moreover, the difference vector calculation unit 306 generates a difference vector of L0 by subtracting the prediction vector of L0 from the motion vector of L0, generates a difference vector of L1 by subtracting the prediction vector of L1 from the motion vector of L1, and outputs them to the entropy encoding unit 316.

The prediction signal generation unit 309 obtains a reference pixel from the decoded image storage unit 303 based on the region position information of the input reference image, and generates a prediction pixel signal.

The prediction error difference generation unit 310 obtains the original image and the prediction pixel signal, and generates a predicted error difference signal by calculating a difference between the original image and the prediction pixel signal.

The orthogonal transformation unit 311 applies orthogonal transformation such as discrete cosine transformation to the predicted error difference signal, and outputs an orthogonal transformation coefficient to the quantization unit 312. The quantization unit 312 quantizes the orthogonal transformation coefficient.

The inverse quantization unit 313 applies inverse quantization to the quantized orthogonal transformation coefficient. The inverse orthogonal transformation unit 314 applies inverse orthogonal transformation to the inverse-quantized coefficient.

The decoded pixel generation unit 315 generates a decoded pixel by adding the predicted error difference signal and the prediction pixel signal. The decoded image including the generated decoded pixel is stored in the decoded image storage unit 303.

The entropy encoding unit 316 applies entropy encoding to the input L0 reference index, L0 difference vector, L0 prediction vector candidate index, L1 reference index, L1 difference vector, L1 prediction vector candidate index, and quantized orthogonal transformation coefficient information, and outputs them as stream data.

According to the first modified example described above, predetermined data can be directly embedded when encoding a moving image.

### Second Modified Example

Next, a moving image processing apparatus will be described according to a second modified example. The moving image processing apparatus in the second modified example is denoted with a numerical code 10D.

<Configuration>

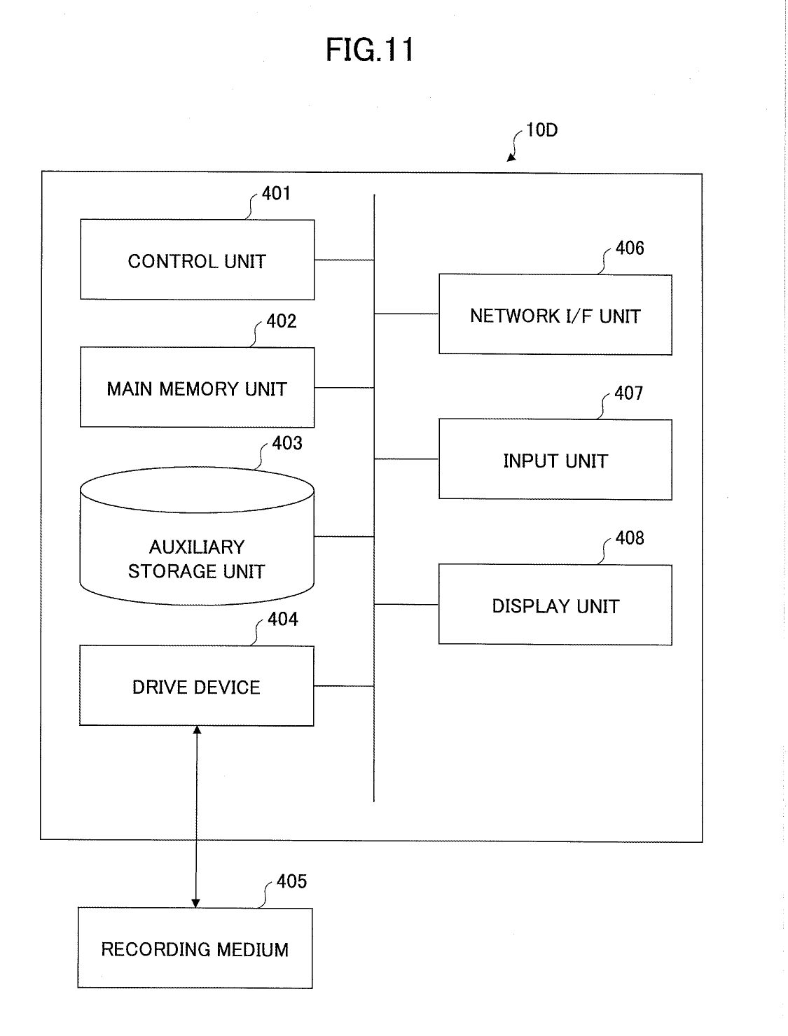

FIG. 11 is a block diagram illustrating an example of a configuration of the moving image processing apparatus 10D according to the second modified example. The moving image processing apparatus 10D is an example of the moving image processing apparatus 10 or the moving image decoding apparatus 20 described in the other embodiments.

As illustrated in FIG. 11, the moving image processing apparatus 10D includes a control unit 401, a main memory unit 402, an auxiliary storage unit 403, a drive unit 404, a network interface unit 406, an input unit 407, and a display unit 408. These elements are connected with each other via a bus to transmit/receive data.

The control unit 401 is a CPU in a computer for controlling devices and for calculating and processing data. The control unit 401 is also a processing unit that executes a program stored in the main memory unit 402 and the auxiliary storage unit 403, receives data from the input unit 407 or storage devices, then calculates and processes the data to output it to the display unit 408, the storage units, and the like.

The control unit 401 can function as each of the units in the embodiments by executing a moving image processing program in each of the embodiments.

The main memory unit 402 includes a ROM (Read-Only Memory) and a RAM (Random Access Memory), which is a memory device for storing or temporarily holding programs and data executed by the control unit 401 such as basic software, namely OS, and application software.

The auxiliary storage unit 403 includes an HDD (Hard Disk Drive), which is a storage device for storing data relevant to the application software.

The drive unit 404 reads a program from a recording medium 405, for example, a flexible disk, to install the program into the storage device.

Also, each of the moving image processing programs of the embodiments is stored in the recording medium 405, which is installed into the moving image processing apparatus 10D via the drive unit 404. The installed moving image processing program can be executed by the moving image processing apparatus 10D.

The network I/F unit 406 is an interface between the moving image processing apparatus 10D and peripheral devices that have communication functions and are connected with a network such as a LAN, a WAN or the like constructed with data transmission lines such as wire/wireless lines.

The input unit 407 includes a keyboard provided with cursor keys, numeral keys, and various function keys, a mouse, a touchpad, etc., for selecting a key on the display screen on the display unit 408. The input unit 407 is also a user interface for a user to enter an operation command or data to the control unit 401.

The display unit 408 includes an LCD (Liquid Crystal Display) on which data input from the control unit 401 is displayed. Note that the display unit 408 may be provided externally; in that case, the moving image processing apparatus 10D has a display control unit.

In this way, the moving image processing or the moving image decoding described in the embodiments may be implemented as a program executed by a computer. It is possible to have a computer execute the program installed from a server or the like to implement the moving image encoding process or the moving image decoding process described above.

Also, it is possible to implement the moving image processing or the moving image decoding described above by recording the program on the recording medium 405 and having a computer or a portable terminal device read the recording medium 405 on which the program is recorded.

Note that various types of recording media 705 can be used including a recording medium that records information optically, electrically, or magnetically such as a CD-ROM, a flexible disk, or an optical magnetic disk, or a semi-conductor memory that records information electrically such as a ROM or a flash memory. Note that the recording media 405 do not include a carrier wave.

The program executed by the moving image processing apparatus 10D is configured to have modules that correspond to the units described in the embodiments. On actual hardware, the control unit 401 reads the program from the auxiliary storage unit 403, then executes it, by which one or more of the units are loaded in the main memory unit 402 to be generated as working units.

Also, the moving image processing or the moving image decoding described in the embodiments may be implemented by one or more integrated circuits.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A moving image processing apparatus comprising:
a storage unit configured to store encoding parameter information generated by encoding each of a plurality of blocks obtained by partitioning an image, the encoding being performed for each of the blocks;
a candidate list generation unit configured to generate a prediction vector candidate list including two prediction vector candidates for a motion vector of each of the blocks to be processed;
a difference vector calculation unit configured to set one bit of predetermined information in selection information for the prediction vector candidates if inter-prediction is applied to the block to be processed, and to calculate a difference vector representing a difference between the motion vector of the block to be processed and one of the prediction vector candidates designated by the selection information; and
a variable-length encoding unit configured to apply variable-length encoding to the encoding parameter information including the difference vector and the selection information.

2. The moving image processing apparatus as claimed in claim 1, further comprising:
a variable-length decoding unit configured to apply variable-length decoding to encoded image data being input to the variable-length decoding unit, and to store decoded encoding parameter information into the storage unit,
wherein the difference vector calculation unit includes
a motion vector restoration unit configured to restore the motion vector by obtaining the prediction vector candidate list generated by the candidate list generation unit, the selection information for the prediction vector candidates included in the encoding parameter information stored in the storage unit, and the difference vector,
a determination unit configured to determine whether the block to be processed has inter-prediction applied, and based on the determination, further determine whether the block to be processed is to have the predetermined information embedded therein,
a selection information update unit configured to update the selection information for the prediction vector candidates included in the encoding parameter information stored in the storage unit, based on the predetermined information, if the block to be processed is to have the predetermined information embedded therein, and
a difference vector update unit configured to update the difference vector included in the encoding parameter information stored in the storage unit, with a difference vector calculated from the prediction vector candidate designated by the updated selection information included in the prediction vector candidate list, and the restored motion vector.

3. The moving image processing apparatus as claimed in claim 2, wherein the determination unit includes
an estimation unit configured to estimate an increased code amount when the selection information for the prediction vector candidates is updated, and
an embedment determination unit configured to determine whether the block to be processed is to have the predetermined information embedded therein, based on the increased code amount.

4. The moving image processing apparatus as claimed in claim 3, wherein the estimation unit includes
a difference vector list generation unit configured to generate a difference vector list including difference vectors calculated from the prediction vector candidates included in the prediction vector candidate list of the block to be processed, and the motion vector,
a code amount estimation unit configured to calculate an estimation value of a code amount of each of the difference vectors included in the difference vector list, and
an increased amount estimation unit configured to calculate a difference between a maximum value and a minimum value among the estimation values of all the difference vectors included in the difference vector list, and to set the difference as the increased code amount,
wherein the embedment determination unit determines that the block to be processed is to have the predetermined information embedded therein if the increased code amount is less than a threshold value.

5. A moving image processing apparatus comprising:
a variable-length decoding unit configured to apply variable-length decoding to moving image data encoded by units of blocks, and to obtain decoded encoding parameter information;
a storage unit configured to store the encoding parameter information;
a determination unit configured to determine whether a block to be processed has inter-prediction applied, and based on the determination, to further determine whether the block to be processed has the predetermined information embedded; and
an information restoration unit configured to restore the predetermined information from selection information for the prediction vector candidates of the block to be processed included in the encoding parameter information stored in the storage unit if the block to be processed has the predetermined information embedded.

6. The moving image processing apparatus as claimed in claim 5, wherein the determination unit includes
an estimation unit configured to estimate an increased code amount if the selection information for the prediction vector candidates has the predetermined information embedded, and
an embedment determination unit configured to determine whether the block to be processed has the predetermined information embedded, based on the increased code amount.

7. The moving image processing apparatus as claimed in claim 6, further comprising:
a candidate list generation unit configured to generate a prediction vector candidate list including two prediction vector candidates for a motion vector of each of the blocks to be processed; and
a motion vector restoration unit configured to restore the motion vector by obtaining the prediction vector candidate list generated by the candidate list generation unit, the selection information for the prediction vector candidates included in the encoding parameter information stored in the storage unit, and the difference vector,
wherein the estimation unit includes
a difference vector list generation unit configured to generate a difference vector list including difference vectors calculated from the prediction vector candidates included in the prediction vector candidate list of the block to be processed, and the motion vector,
a code amount estimation unit configured to calculate an estimation value of a code amount of each of the difference vectors included in the difference vector list, and
an increased amount estimation unit configured to calculate a difference between a maximum value and a minimum value among the estimation values of all the difference vectors included in the difference vector list, and to set the difference as the increased code amount,
wherein the embedment determination unit determines that the block to be processed has the predetermined information embedded if the increased code amount is less than a threshold value.

8. A moving image processing method executed by a computer including a storage unit configured to store encoding parameter information generated by encoding each of a plurality of blocks obtained by partitioning an image, the encoding being performed for each of the blocks, the method comprising:
generating a prediction vector candidate list including two prediction vector candidates for a motion vector of each of the blocks to be processed;
setting one bit of predetermined information in selection information for the prediction vector candidates if inter-prediction is to be applied to the block to be processed;
calculating a difference vector representing a difference between the motion vector of the block to be processed and one of the prediction vector candidates designated by the selection information; and
applying variable-length encoding to the encoding parameter information including the difference vector and the selection information.

9. A moving image processing method executed by a computer, the method comprising:
applying variable-length decoding to moving image data encoded by units of blocks, and obtaining decoded encoding parameter information;
storing the encoding parameter information into a storage unit;
determining whether a block to be processed has inter-prediction applied, and based on the determination, further determining whether the block to be processed has the predetermined information embedded; and
restoring the predetermined information from selection information for the prediction vector candidates of the block to be processed included in the encoding parameter information stored in the storage unit if the block to be processed has the predetermined information embedded.

10. A non-transitory computer-readable recording medium having a program stored therein for causing a computer to execute a process of moving image processing, the computer including a storage unit configured to store encoding parameter information generated by encoding each of a plurality blocks obtained by partitioning an image, the encoding being performed for each of the blocks, the process comprising:
generating a prediction vector candidate list including two prediction vector candidates for a motion vector of each of the blocks to be processed;
setting one bit of predetermined information in selection information for the prediction vector candidates if inter-prediction is to be applied to the block to be processed;
calculating a difference vector representing a difference between the motion vector of the block to be processed and one of the prediction vector candidates designated by the selection information; and
applying variable-length encoding to the encoding parameter information including the difference vector and the selection information.

11. A non-transitory computer-readable recording medium having a program stored therein for causing a computer to execute a process of moving image processing, the process comprising:
applying variable-length decoding to moving image data encoded by units of blocks, and obtaining decoded encoding parameter information;
storing the encoding parameter information into a storage unit;
determining whether a block to be processed has inter-prediction applied, and based on the determination, further determining whether the block to be processed has the predetermined information embedded; and
restoring the predetermined information from selection information for the prediction vector candidates of the block to be processed included in the encoding parameter information stored in the storage unit if the block to be processed has the predetermined information embedded.
